(19) United States
(12) Patent Application Publication
(10) Pub. No.: US 2019/0306779 A1
(43) Pub. Date: Oct. 3, 2019

(54) VEHICLE COMMUNICATION CONTROL METHOD AND VEHICLE COMMUNICATION DEVICE

(71) Applicant: HONDA MOTOR CO., LTD., Tokyo (JP)

(72) Inventor: Susumu Iwamoto, Tokyo (JP)

(21) Appl. No.: 16/351,548

(22) Filed: Mar. 13, 2019

(30) Foreign Application Priority Data
Mar. 28, 2018 (JP) 2018-062696

(51) Int. Cl. H04W 48/02; H04W 4/40

(52) U.S. Cl. CPC H04W 48/02; H04W 4/40

(57) ABSTRACT

A vehicle communication control method for controlling communication between a vehicle communication device mounted in a vehicle and an out-of-vehicle communication device includes causing one or more computers to determine whether an information usage amount that is an index value indicating the amount of information communicated between the vehicle communication device and the out-of-vehicle communication device has exceeded a predetermined amount and to restrict communication between the vehicle and the out-of-vehicle communication device in a case that the predetermined amount has been exceeded.

### CROSS-REFERENCE TO RELATED APPLICATION

Priority is claimed on Japanese Patent Application No. 2018-062696, filed Mar. 28, 2018, the content of which is incorporated herein by reference.

### BACKGROUND

### Field of the Invention

The present invention relates to a vehicle communication control method and a vehicle communication device.

### Description of Related Art

Recently, research on automated vehicle control has been carried out. With respect to this, a technique for providing various types of content from transmission sources such as out-of-vehicle terminals to in-vehicle apparatuses is known (refer to JP 2009-521019T, for example). In recent years, it has been conceived that various types of information such as entertainment information and advertisement information be communicated in addition to communication of information about vehicle driving with the development of vehicle-to-vehicle communication, communication between a vehicle and an out-of-vehicle terminal, and the like. Furthermore, provision of communication services with a higher speed and larger capacity is expected in next-generation mobile communication systems.

### SUMMARY

However, in conventional techniques, cases occur in which a network capacity is limited and users may not be able to effectively use a network in a case that a system in which a vehicle performs communication for transmitting various types of content is provided.

An object of the present invention devised in view of the aforementioned circumstances is to provide a vehicle communication control method and a vehicle communication device capable of effectively using communication resources of a vehicle having a communication function.

A vehicle communication control method and a vehicle communication device according to the present invention employed the following configurations.

(1): A vehicle communication control method according to one aspect of the present invention is a vehicle communication control method for controlling communication between a vehicle communication device mounted in a vehicle and an out-of-vehicle communication device, in which one or more computers determine whether an information usage amount that is an index value indicating the amount of information communicated between the vehicle and the out-of-vehicle communication device has exceeded a predetermined amount and restrict communication between the vehicle and the out-of-vehicle communication device in a case that the information usage amount has exceeded the predetermined amount.

(2): In the aspect of (1), there is a case in which the vehicle communication device receives content reproduced by an on-board device from the out-of-vehicle communication device, and the one or more computers determine the type of the content reproduced in the on-board device that performs communication and restrict the communication according to the determined content type.

(3): In the aspect of (1), the vehicle communication device performs communication with respect to traveling of the vehicle, and the one or more computers exclude communication of the vehicle communication device with respect to traveling from restriction targets for the communication or set a low priority in a case that the communication is selected as a restriction target for the communication.

(4): In the aspect of (1), the vehicle communication device performs communication for acquiring a surrounding situation of the vehicle, and the one or more computers exclude the communication for acquiring the surrounding situation of the vehicle from restriction targets for the communication or set a low priority in a case that the communication is selected as a restriction target for the communication.

(5): In the aspect of (1), the vehicle communication device performs communication with respect to driving assistance or automated driving of the vehicle, and the one or more computers exclude the communication of information about driving assistance or automated driving of the vehicle from restriction targets for the communication or set a low priority in a case that the communication is selected as a restriction target for the communication.

(6): In the aspect of (1), the one or more computers exclude communication of information about a state of an occupant of the vehicle from restriction targets for the communication or set a low priority in a case that the communication is selected as a restriction target for the communication.

(7): In the aspect of (1), the one or more computers exclude communication of information about an emergency notification of the vehicle from restriction targets for the communication or set a low priority in a case that the communication is selected as a restriction target for the communication.
(8): In the aspect of (1), one or more computers exclude traveling of the vehicle, or communication of information related to protection or biometric information of an occupant of the vehicle from restriction targets for the communication or set a low priority in a case that the communication is selected as a restriction target for the communication.

(9): In the aspect of (1), the one or more computers preferentially restrict communication with respect to content including images.

(10): In the aspect of (1), the one or more computers receive an operation of selecting content for which the communication is restricted by an occupant of the vehicle, select the content for which the communication is restricted according to the received operation and preferentially restrict the communication with respect to the selected content.

(11): In the aspect of (1), the predetermined amount is set for the vehicle communication device installed in the vehicle.

(12): In the aspect of (1), the vehicle communication device mounted in the vehicle and the out-of-vehicle communication device are connected in a wired or wireless manner, and the one or more computers set the predetermined amount by summing the communication volume of the vehicle communication device and the communication volume of a communication device other than the vehicle communication device, which is brought into the vehicle, or the communication volume of the out-of-vehicle communication device.

(13): A vehicle communication control method according to one aspect of the present invention is a vehicle communication control method between a vehicle communication device mounted in a vehicle and an out-of-vehicle communication device, in which one or more computers connect the vehicle communication device to the out-of-vehicle communication device or a communication device brought into the vehicle through communication and switch communication volumes between the vehicle communication device and the out-of-vehicle communication device or the communication device brought into the vehicle.

(14): A vehicle communication control method according to one aspect of the present invention is a vehicle communication control method in which one or more computers perform communication such that a communication volume or a data usage amount set in a communication device brought into a vehicle is not consumed in a case that the communication device is caused to communicate with an out-of-vehicle communication device through a vehicle communication device in a state in which the vehicle communication device mounted in the vehicle and the out-of-vehicle communication device are wirelessly connected.

(15): In the aspect of (14), in a case that the one or more computers set a traveling route of the vehicle, the one or more computers perform route setting for preferentially selecting a route passing through a connection area in which the one or more computers are connectable to the out-of-vehicle communication device.

(16): A vehicle communication control method according to one aspect of the present invention is a vehicle communication control method in which, in a case that a predetermined amount that restricts an amount of traffic of a vehicle communication device which is installed in a vehicle and can communicate with an out-of-vehicle communication device is set by an occupant of the vehicle, one or more computers perform settlement for the amount of traffic through any one of the vehicle communication device and a communication device other than the vehicle communication device, wherein the other communication device can communicate with the vehicle communication device and the out-of-vehicle communication device.

(17): In the aspect of (16), in a case that the vehicle communication device is used for communication between other communication devices used by a plurality of occupants and the out-of-vehicle communication device, the one or more computers handle details of communication of the vehicle communication device as details of communication between the other communication devices and the out-of-vehicle communication device and add the amount of traffic of the details of communication to the other communication devices.

(18): A vehicle communication device according to one aspect of the present invention is a vehicle communication device for controlling communication between a vehicle and another communication device, including: a determination unit which is configured to determine whether an information usage amount that is an index value indicating the amount of information communicated between the vehicle and the other communication device has exceeded a predetermined amount; and a controller which restricts communication between the vehicle and the other communication device in a case that the determination unit determines that the information usage amount has exceeded the predetermined amount.

According to the aspects of (1) to (18), it is possible to effectively use communication resources of a vehicle including a communication function.

According to the aspects of (3) to (8), further, it is possible to improve protection of an occupant by securing communication with respect to driving of a vehicle and protection of the occupant.

According to the aspects of (9) and (10), further, it is possible to restrict communication according to content transmitted to a vehicle communication device.

### BRIEF DESCRIPTION OF THE DRAWINGS

FIG. 1 is a diagram showing an example of a configuration of a vehicle communication system to which a vehicle communication device is applied.

FIG. 2 is a diagram showing an example of a state in which a communication volume of a vehicle communication device and a communication volume of an in-vehicle user terminal are summed.

FIG. 3 is a diagram showing an example of display details of a management screen for switching communication volumes.

FIG. 4 is a diagram showing an example of details of a communication volume automatically set in a case that a user gets out of a host vehicle.

FIG. 5 is a diagram showing an example of details of a setting screen for selecting content that is a restriction target.

FIG. 6 is a diagram showing an example of details of an operation screen.

FIG. 7 is a diagram showing an example of details of a setting screen for restriction of communication on the side of a vehicle communication device during ridesharing.

FIG. 8 is a flowchart showing an example of a flow of a process performed in a vehicle communication system.

FIG. 9 is a diagram showing an example of a hardware configuration of a vehicle communication device.

### DESCRIPTION OF EMBODIMENTS

Hereinafter, an embodiment of a vehicle communication system to which a vehicle communication control method and a vehicle communication device are applied will be described with reference to the drawings.

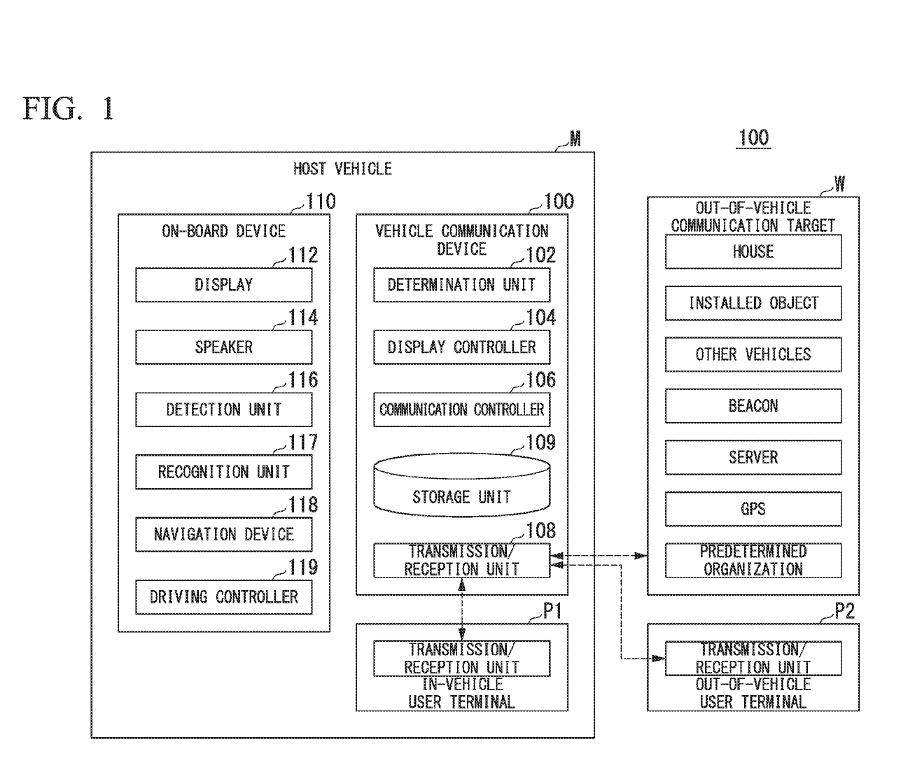

FIG. 1 is a diagram showing an example of a configuration of a vehicle communication system 1 to which a vehicle communication device is applied. The vehicle communication system 1 is a system for performing communication between a host vehicle M and a communication device included in an out-of-vehicle communication target W. For example, the vehicle communication system 1 may include the host vehicle M, an in-vehicle user terminal P1, an out-of-vehicle user terminal P2, and an out-of-vehicle communication device. In the vehicle communication system 1, the host vehicle M and an (out-of-vehicle) communication device outside of the host vehicle M are connected in a wired or wireless manner.

For example, the host vehicle M may be an automated driving vehicle including a communication function. The host vehicle M may be a manual driving vehicle having a driving assistance function. The host vehicle M includes a vehicle communication device 100, an on-board device 110 and the in-vehicle user terminal P1.

The vehicle communication device 100 is a communication terminal installed in the host vehicle M. The vehicle communication device 100 receives content reproduced by the on-board device 110 from an external communication device and transmits various types of information to an external communication device. The vehicle communication device 100 is used for communication with an out-of-vehicle communication device as a separate component inside the host vehicle M and is also used as a device that intervenes in communication between the in-vehicle user terminal P1 put into the vehicle and used by a user and an out-of-vehicle communication device. Communication is performed between the vehicle communication device 100 and the user terminals P1 and P2 in a wireless or wired manner.

An out-of-vehicle communication device may be a communication device included in the out-of-vehicle communication target W, for example, and includes a base station of a wireless local area network (LAN), a wireless base station of a common carrier, a communication device of other vehicles capable of performing vehicle-to-vehicle communication, a communication device of equipment installed on a road or in a facility, a beacon on a road, a server connected to a network, a GPS and the like. The out-of-vehicle communication device may include the out-of-vehicle user terminal P2.

The vehicle communication device 100 includes a determination unit 102, a display controller 104, a communication controller 106, a transmission/reception unit 108 and a storage unit 109. For example, these components may be realized by a processor such as a central processing unit (CPU) executing a program (software). This functional part may be realized by hardware such as a large scale integration (LSI) circuit, an application specific integrated circuit (ASIC) and a field-programmable gate array (FPGA) or realized by software and hardware in cooperation.

The determination unit 102 monitors an information usage amount that is an index value indicating the amount of information transmitted to and received from the transmission/reception unit 108. The determination unit 102 compares the information usage amount with a predetermined amount (threshold value) to determine whether the information usage amount for information communicated between the host vehicle M and other communication devices exceeds the predetermined amount.

The display controller 104 performs a display process of display details to be displayed on a display 112 in the on-board device 110 which will be described later. The display controller 104 performs a display process of display details to be displayed on a display unit of the in-vehicle user terminal P1 through the transmission/reception unit 108.

The communication controller 106 restricts communication between the vehicle communication device 100 and other communication devices in a case that it is determined that the information usage amount of the vehicle communication device 100 and other out-of-vehicle communication devices exceeds the predetermined amount on the basis of determination results of the determination unit 102. Restrictions on communication include restrictions on a communication speed, restrictions on a period and time in which high-speed communication can be performed and other restrictions.

The transmission/reception unit 108 communicates with out-of-vehicle communication devices. An out-of-vehicle communication device is a communication device included in each communication target W. The transmission/reception unit 108 communicates with other vehicles present around the host vehicle M using a cellular network, a Wi-Fi (registered trademark) network, Bluetooth (registered trademark), dedicated short range communication (DSRC) or the like or communicates with various server devices through a wires base station. The transmission/reception unit 108 may perform wired communication by being connected to a cable. In this case, the transmission/reception unit 108 includes a network interface card (NIC) for connecting to other communication targets.

The transmission/reception unit 108 is controlled by the communication controller 106 to adjust an amount of traffic with respect to other communication devices. The transmission/reception unit 108 decreases communication speeds and data amounts of communication with other communication devices in a case that amounts of communication have been limited.

The storage unit 109 is a storage device such as a hard disk drive (HDD) or a flash memory. The storage unit 109 stores information such as identification information for identifying a user, an amount of traffic in a predetermined period depending on a communication plan set by a user, and an information usage amount of the transmission/reception unit 108.

The on-board device 110 may include the display 112, a speaker 114, a detection unit 116, a recognition unit 117, a navigation device 118 and a driving controller 119, for example.

For example, the display 112 is a display device installed in the host vehicle M. The display 112 may be a touch panel type liquid crystal display, for example, and receives an operation of an occupant by interoperating with the vehicle communication device 100 and displays information. The speaker 114 provides audio information with respect to the interior of the vehicle.

The detection unit 116 includes various sensors with respect to the vehicle, for example, and detects a surrounding situation outside the vehicle and a state of an occupant. For example, the detection unit 116 includes an out-of-vehicle camera, a radar device, a finder and an in-vehicle camera. The detection unit 116 includes an out-of-vehicle camera and an acceleration sensor and detects variations generated in the host vehicle M, for example. The detection unit 116 captures an image of an occupant inside the vehicle and detects variation generated with respect to the occupant, for example.

The recognition unit 117 recognizes a surrounding situation outside the vehicle and a state with respect to an occupant inside the vehicle on the basis of detection results detected by the detection unit 116.

For example, the recognition unit 117 recognizes states such as the position, speed and acceleration of an object present around the host vehicle M on the basis of information input from the out-of-vehicle camera, the radar device and the finder through an object recognition device. For example, the position of the object may be recognized as a position on absolute coordinates having a representative point (the center of gravity, the center of the drive shaft or the like) of the host vehicle M as the origin and used for control. The position of the object may be represented as a representative point of the object, such as the center of gravity or a corner, or may be represented as a representative region. “States” of the object may include the acceleration and jerk of the object or an “action state” (for example, whether lane change is being performed or is intended to be performed).

The recognition unit 117 may recognize an abnormality such as collision occurring in the host vehicle M on the basis of recognition results of the object recognition device, for example. The recognition unit 117 compares an image captured by the in-vehicle camera with a predetermined sampling interval and recognizes an abnormality such as drowsiness or unconsciousness of an occupant from analysis results of the image.

The navigation device 118 performs route guide to a destination set by an occupant. The navigation device 118 may perform route guide of driving assistance or automated driving in a case that the host vehicle M is a driving assistance or automated driving vehicle.

The navigation device 118 may identify the position of the host vehicle M using a global navigation satellite system (GNSS) receiver, for example. The navigation device 118 stores first map information in a storage device such as a hard disk drive (HDD) or a flash memory. For example, the navigation device 118 may determine a route (hereinafter, a route on a map) from the identified position of the host vehicle M (or an arbitrary input position) to a destination input by an occupant through the display 112 with reference to the first map information.

The first map information may be information representing road shapes according to links indicating roads and nodes connected by links, for example. The first map information may include curvature and point of interest (POI) information of roads, and the like.

The navigation device 118 may perform route guide using the display 112 on the basis of a route on a map. The navigation device 118 may be realized by functions of a user terminal such as a smartphone or a tablet terminal possessed by an occupant, for example.

Furthermore, the navigation device 118 stores second map information in a storage device such as an HDD or a flash memory. The second map information is map information with higher-accuracy than the first map information. For example, the second map information may include information on the centers of lanes, information on the boundaries of lanes, or the like. The second map information may include road information, traffic regulations information, address information (addresses and zip codes), facility information, telephone number information, and the like. The second map information may be updated at any time through communication between the transmission/reception unit 108 and other devices.

The navigation device 118 divides a route on a map into a plurality of blocks (divides the route into intervals of 100 m in a vehicle traveling direction, for example) and determines a recommended lane for each block with reference to the second map information. The navigation device 118 determines which lane is a traveling lane from the left. When a route on a map includes a branch point, the navigation device 118 determines recommended lanes such that the host vehicle M can travel on a reasonable route for traveling to a branch destination.

The driving controller 119 performs control for causing the host vehicle M to automatically travel. For example, the driving controller 119 may realize a function of artificial intelligence (AI) and a function of a model provided in advance in parallel. For example, a function of “recognizing an intersection” may be realized by performing recognition of an intersection using deep learning or the like and recognition based on conditions provided in advance (which include a signal which can be pattern-matched, road markings, and the like) in parallel and assigning scores to both the recognitions to integrally evaluate the recognitions. Accordingly, reliability of driving assistance or automated driving is secured.
The driving controller 119 generates a target trajectory along which the host vehicle M will automatically travel (without depending on an operation of a driver) in the future such that the host vehicle M travels in a recommended lane determined by the navigation device 118 and can cope with a surrounding situation thereof recognized by the recognition unit 117 in principle. For example, a target trajectory may include a speed factor. For example, a target trajectory is represented as a sequential arrangement of points (trajectory points) at which the host vehicle M will arrive.
A trajectory point is a point at which the host vehicle M will arrive for each predetermined traveling distance (for example, approximately several meters) in a distance along a road, and a target speed and a target acceleration for each predetermined sampling time (for example, approximately zero comma several seconds) are generated as a part of a target trajectory separately. A trajectory point may be a position at which the host vehicle M will arrive at a sampling time for each predetermined sampling time. In this case, information on a target speed and a target acceleration are represented by a spacing between trajectory points. The driving controller 119 changes a target trajectory on the basis of surrounding situations of the host vehicle M recognized by the recognition unit 117. The driving controller 119 changes a target trajectory on the basis of information acquired through communication such as vehicle-to-vehicle communication, road-to-vehicle communication, GPS communication, server communication, and communication with a terminal of a pedestrian or the like.
The driving controller 119 causes the host vehicle M to travel along the generated target trajectory by controlling a travel driving power output device such as an engine and a motor, a brake device and a steering device.

### [Operation of Vehicle Communication System 1]

The amount of traffic of the vehicle communication device 100 is set according to details of a contract between a user and a common carrier. For example, the amount of traffic of the vehicle communication device 100 may be set monthly on the basis of the details of the contract between the user and the common carrier. The amount of traffic is set according to various plans depending on the purpose of use of a user and an expected usage amount which are set by a service provider.

For example, in a case that the user sets a monthly usage upper limit with respect to the amount of traffic, the user can perform communication using the vehicle communication device 100 at an unrestricted communication speed for the amount of traffic set at a fixed price. When the set amount of traffic is exceeded, the user performs communication in a state in which communication has been restricted by the vehicle communication device 100 until the next month. A state in which communication has been restricted may include a state in which a communication speed has decreased, a state in which excess traffic is meter-rate-charged, and the like, for example. Communication restriction of the vehicle communication device 100 is canceled the next month and unrestricted communication can then be performed until the set amount of traffic is exceeded. The communication controller 106 may restrict communication of the vehicle communication device 100 on the basis of a congestion state of communication between the vehicle communication device 100 and the out-of-vehicle communication target W.

The determination unit 102 monitors an information usage mount for information transmitted to and received from the transmission/reception unit 108 on the basis of information about the amount of traffic of the user stored in the storage unit 109. For example, the information usage amount may be a total value for the mount of information (for example, packets) of data such as sound, text and images transmitted and received between the vehicle communication device 100 and other out-of-vehicle communication targets. For example, the determination unit 102 may monitor an uplink traffic amount in a case that communication is performed from the host vehicle M to an out-of-vehicle communication device. In addition, the determination unit 102 may monitor a downlink traffic amount in a case that communication is performed from an out-of-vehicle communication device to the host vehicle M. The determination unit 102 outputs determination results to the communication controller 106.

When an amount of information in a predetermined unit has been transmitted to and received from the transmission/reception unit 108, the determination unit 102 correlates the amount of information in the predetermined unit with a time and stores the correlated information in the storage unit 109. The determination unit 102 integrates the amount of information in the predetermined unit in a predetermined period at a predetermined timing on the basis of the information stored in the storage unit 109. The determination unit 102 compares the amount of information transmitted to and received from the transmission/reception unit 108 with a threshold value at a predetermined timing using a set information usage amount upper limit as the threshold value. The determination unit 102 determines that an information usage amount for information communicated between the host vehicle M and the out-of-vehicle communication device has exceeded a predetermined amount in a case that a total amount for information is equal to or greater than the threshold value.

The determination unit 102 outputs the determination results to the display controller 104 and the communication controller 106. The communication controller 106 restricts communication between the host vehicle M and the out-of-vehicle communication device by controlling the transmission/reception unit 108 in a case that the determination unit 102 determines that the information usage amount has exceeded the predetermined amount. For example, the communication controller 106 may decrease a communication speed after restriction to below a communication speed before restriction. The predetermined amount may also be set on the side of the vehicle communication device 100 in a case that the in-vehicle user terminal P1 is present.

The vehicle communication device 100 can perform communication using the communication function thereof even in a case that a terminal other than the vehicle communication device 100 is not present and is not affected by communication restriction of a terminal other than the vehicle communication device 100. For example, even if communication of the in-vehicle user terminal P1 possessed by an occupant is restricted, the communication speed of the vehicle communication device 100 is not affected and the communication volume thereof is secured.

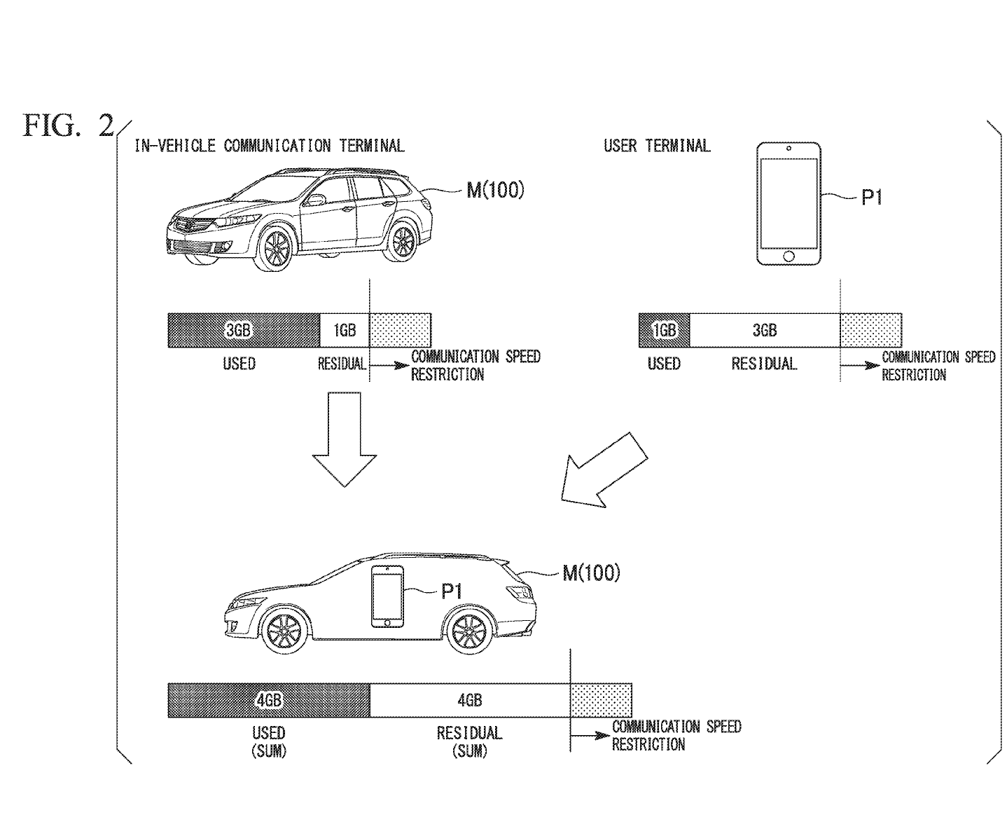

The communication controller 106 sums the communication volume of the vehicle communication device 100 and the communication volume of the in-vehicle user terminal P1 brought into the host vehicle M from the outside of the vehicle in a case that the vehicle communication device 100 and an out-of-vehicle communication device communicate with each other in a wired or wireless manner FIG. 2 is a diagram showing an example of a state in which the communication volume of the vehicle communication device 100 and the communication volume of the in-vehicle user terminal P1 are summed Summing communication volumes may be adding a part or all of the communication volume of the user terminal P1 to the communication volume of the vehicle communication device 100 to increase an information usage amount that can be transmitted and received in the vehicle communication device 100, for example. The communication controller 106 sets the predetermined amount for the vehicle communication device 100 on the basis of the sum communication volume.

For example, in a case that the communication volumes of the vehicle communication device 100 and the user terminal P1 are both 4 GB, a maximum value of the sum communication volume is 8 GB. When a used communication volume of the vehicle communication device 100 is 3 GB and a used communication volume of the user terminal P1 is 1 GB during summing, for example, a total value of the used communication volumes is 4 GB and a total value of the remaining communication volumes is 4 GB.

When communication volumes are summed, it is desirable that common carriers used by terminal devices be the same carrier. A common carrier may manage a user of each terminal device using a management server, for example. The management server manages personal information of a user of each terminal and manages a communication volume for communication performed by the user through a terminal device. Each terminal device may be identified using a subscriber identity module (SIM) card, for example. The management server may change management information on a communication volume of each terminal device on the basis of an operation of a user through a terminal device, for example. The communication controller 106 may control communication of the vehicle communication device 100 on the basis of management information acquired from the management server, for example.

When the predetermined amount is set according to summing of the communication volumes, an upper value for data use set as a communication restriction of the vehicle communication device 100 can be reduced to below the communication volume of the in-vehicle user terminal P1 and the user can be provided with a satisfactory data communication service.

When the communication volume of the vehicle communication device 100 and the communication volume of the in-vehicle user terminal 1 are summed, the display controller 104 may display a screen indicating proportions in the sum of the communication volumes on the display 112 or the screen of the user terminal P1.

When the communication volumes are summed, the display controller 104 may display an operation screen through which an occupant will select whether to sum on the display 112 or the screen of the user terminal P1.

This is because automatic summing of the communication volumes is likely to be inconvenient. When the communication volumes have been summed, the display controller 104 may display an operation screen for cancelling the summing on the display 112 or the screen of the user terminal P1. The display controller 104 may display an operation screen for selecting whether initial communication volume proportions will be maintained or changed to any other proportions in a case that the summing of the communication volumes is canceled on the display 112 or the screen of the user terminal P1.

If the vehicle communication device 100 and the user terminal P1 have the same common carrier in a case that the communication volumes are summed, the common carrier may mitigate an upper limit of communication volumes and provide a communication service. When the communication volumes are summed, the communication service may be provided using the sum communication volume in either of the vehicle communication device 100 or the user terminal P1 selected by the user.

When the vehicle communication device 100 and an out-of-vehicle communication device or the in-vehicle user terminal P1 are connected through communication, the communication controller 106 may cause communication volumes to be switched between the vehicle communication device 100 and the out-of-vehicle communication device or the in-vehicle user terminal P1. For example, switching communication volumes may be an operation of each of the vehicle communication device 100, the in-vehicle user terminal P1 and the out-of-vehicle communication device to add a part or all of the communication volume thereof to the communication volume of another terminal to increase the communication volume of the other terminal (or vice versa).

For example, in a case that any of the vehicle communication device 100, the in-vehicle user terminal P1, and the out-of-vehicle communication device is a communication device that is a communication restriction target, communication restriction is canceled in the host vehicle M in a case that the communication device that is the communication restriction target communicates with a communication device that is not a communication restriction target to acquire a surplus communication volume from the communication device that is not a communication restriction target.

The communication controller 106 transmits information on authentication of the user terminal P1 performed in a case that the user terminal P1 is connected to the vehicle communication device 100 to a management server of the common carrier. The management server may change management information such that communication volumes of terminal devices are switched on the basis of an operation of a user through a terminal device, for example. The communication controller 106 may control communication of the vehicle communication device 100 on the basis of the management information acquired from the management server, for example.

The display controller 104 may display a screen representing communication volume switching proportions on the display 112 or the display unit of the user terminal P1 in a case that the vehicle communication device 100 and the out-of-vehicle communication device or the in-vehicle user terminal P1 switch communication volumes with each other.

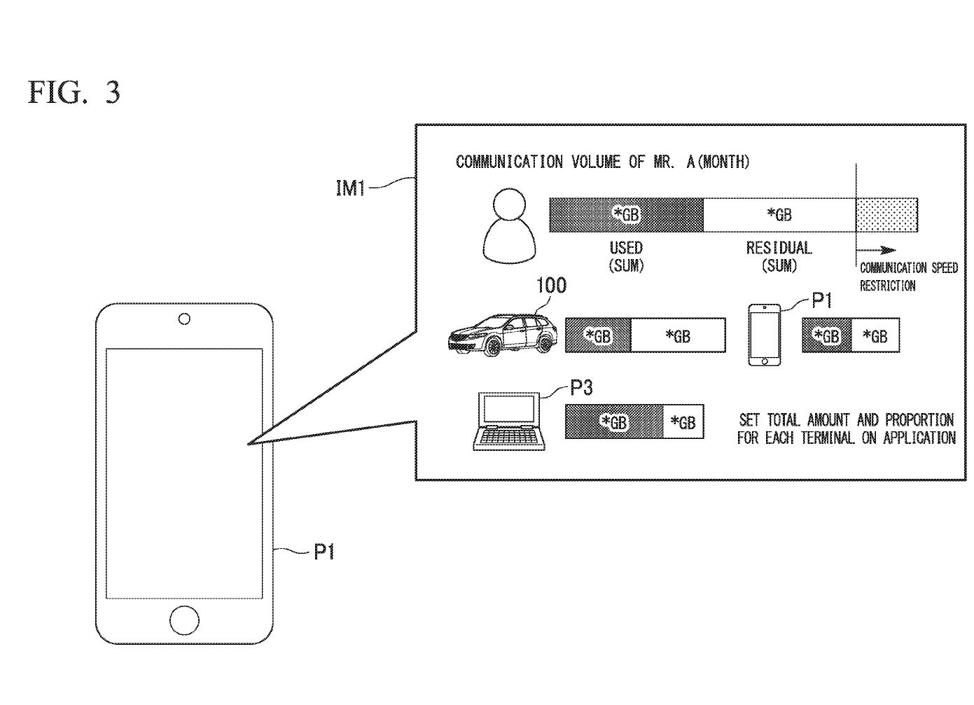

FIG. 3 is a diagram showing an example of details of display of a management screen IM1 for switching communication volumes. For example, the management screen IM1 displayed through an application of the user terminal P1 may display a communication volume (a used communication volume and a remaining value of the communication volume) of management targets that are each of the vehicle communication device 100, an out-of-vehicle communication device (for example, a terminal device P3 such as a PC installed in a user's house), and the user terminal P1 and a total value of the communication volumes of all management targets. In the management screen IM1, the user sets the communication volumes of the management targets such that the communication volumes are switched within the range of a total value of remaining values of the communication volumes.

The user terminal P1 transmits information on setting of the switched communication volumes to the management server of the common carrier on the basis of user settings. The management server changes the communication volumes of the management targets on the basis of the received setting information. The management server may automatically change the communication volumes of the management targets according to use states of the management targets on the basis of setting conditions of the user.

For example, in a case that the user brings the user terminal P1 into the host vehicle M, remaining values of the communication volumes of the vehicle communication device 100 and the user terminal P1 may be automatically summed in a case that the host vehicle M is being used (refer to FIG. 2).

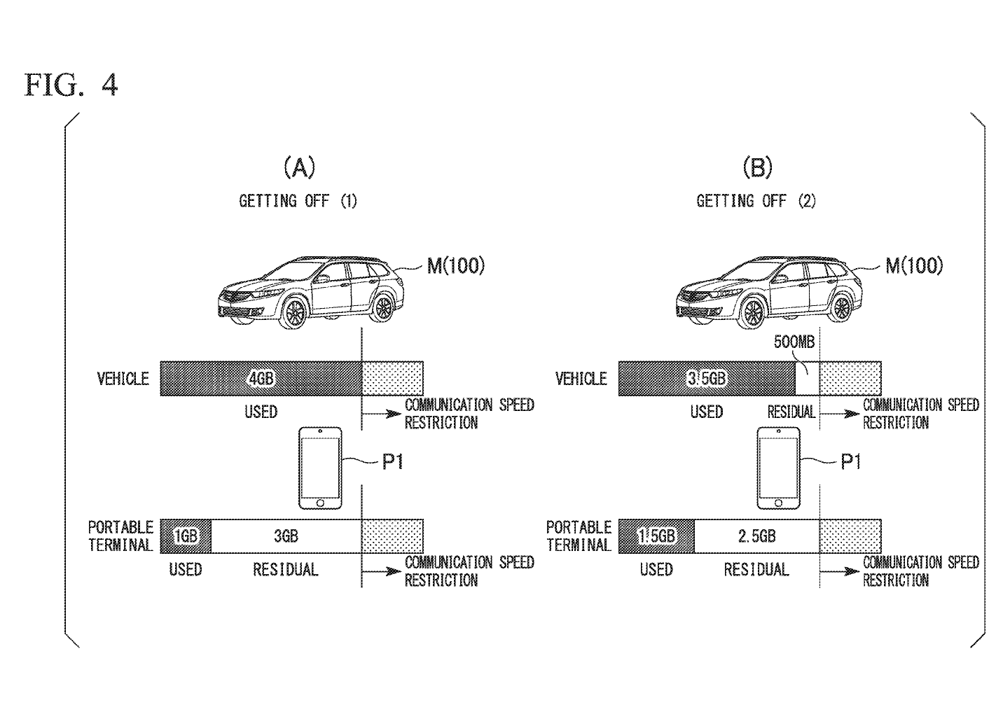

FIG. 4 is a diagram showing an example of details of communication volumes automatically set in a case that the user gets out of the host vehicle M. As shown in FIG. 4A, the entire remaining value of the total value of the communication volumes may be automatically provided to the user terminal P1 in a case that the user gets out of the host vehicle M. However, a communication volume is provided to the user terminal P1 within a range that does not exceed a maximum value of a communication volume in a case that contract with the user terminal P1 was made.

The remaining value of the total value of the communication volumes may be automatically provided to the user terminal P1 at any apportionment on the basis of user settings in a case that the user has left the host vehicle M. For example, it may be possible to leave a predetermined communication volume (for example, 500 MB) in the vehicle communication device 100 and provide the remaining value of the total value of the communication volumes to the user terminal P1, as shown in FIG. 4B.

When the communication volumes are switched, the display controller 104 may display an operation screen for causing an occupant to select whether to switch the communication volumes on the display 112 or the screen of the user terminal P1. The user can be provided with a satisfactory data communication service without restriction according to communication volume switching.

When the in-vehicle user terminal P1 communicates with an out-of-vehicle communication device through tethering via the vehicle communication device 100 in a state in which the vehicle communication device 100 and the out-of-vehicle communication device are wirelessly connected, the communication controller 106 may set the communication volume or data usage amount set in the in-vehicle user terminal P1 such that none of the communication volume or data usage amount is consumed.

For example, the communication controller 106 may connect the vehicle communication device 100 connected to the in-vehicle user terminal P1 to a base station of an out-of-vehicle wireless LAN and minimize an increase in an information usage amount that is a target for restriction of the in-vehicle user terminal P1. The communication controller 106 may connect the vehicle communication device 100 to the in-vehicle user terminal P1 and connect the in-vehicle user terminal P1 to the base station of the out-of-vehicle wireless LAN. Accordingly, the user can be provided with a satisfactory data communication service without restriction within the range of resources of the wireless LAN. The wireless LAN is an example and other communication means may be used as long as communication is not restricted.

Details of restriction on communication may be selected by the user. For example, the communication controller 106 may preferentially restrict communication with respect to content selected through an operation screen displayed on the display 112 by the user.

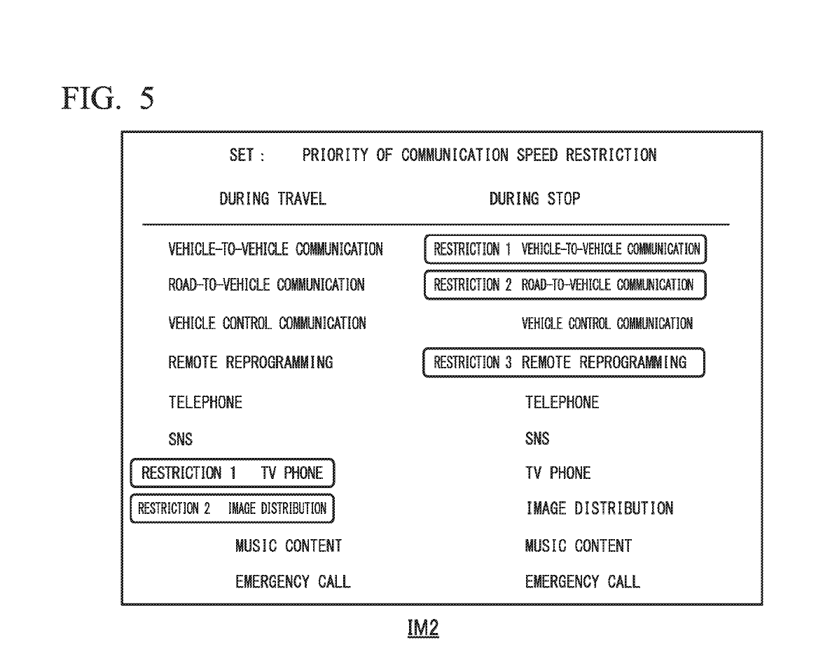

FIG. 5 is a diagram showing an example of details of a setting screen IM2 for selecting content that is a restriction target. The operation screen IM2 is displayed on the display 112 in a case that communication needs to be restricted. For example, the operation screen IM2 may display a plurality of items of content that are restriction target candidates as button images. For example, the display controller 104 may read the operation screen IM2 for selecting communication restriction content from the storage unit 109 and cause the display 112 to display the operation screen IM2.

When an occupant of the host vehicle M touches the operation screen IM2 displayed on the display 112, the display controller 104 receives the operation of the occupant and outputs a selection result to the communication controller 106.

For example, the user may select content that restricts communication in each of a state in which the host vehicle M is traveling and a state in which the host vehicle M is stopped.

In the example of FIG. 5, the user selects content of a TV telephone and image distribution that are not used in a case that the host vehicle M is traveling as restriction targets. The user selects content such as vehicle-to-vehicle communication, road-to-vehicle communication, and remote reprogramming as restriction targets in a state in which host vehicle M is stopped.

When a selected application is started on the basis of a selection result, the communication controller 106 preferentially performs restriction on communication with respect to the content of the application. The content for which communication is restricted may be content including images with a large information usage amount, for example. The content including images may include content with respect to augmented reality (AR) and virtual reality (VR) in addition to movies and TV, network video, TV/video conferences, and the like, for example.

Since content including images include a large volume of data to be transmitted, there is a possibility that many other functions with respect to communication may need to be restricted in the vehicle communication device 100. Hence, the communication controller 106 restricts communication with respect to content including images and does not restrict communication with respect to content having a small communication volume in a case that restriction on communication is executed. The communication controller 106 may decrease a resolution of images and restrict a data usage amount per unit time in addition to simply reducing an image distribution speed in a case that communication of content including images is restricted.

The communication controller 106 may cancel restriction on content on the basis of an operation of an occupant. For example, in a case that a surplus is generated in a communication volume for the reason that communication with respect to driving assistance or automated driving becomes unnecessary in a case that the host vehicle M is stopped for a long time, the communication controller 106 may cancel restriction on communication with respect to content on the basis of an operation performed by the occupant.

For example, the communication controller 106 may monitor a communication state of the transmission/reception unit 108, and in a case that a surplus is generated in the communication volume to a degree to which restriction on the restricted content can be canceled, instruct the display controller 104 to display an operation screen for canceling restriction on the content on the display 112. When an operation performed by the occupant is received, the display controller 104 outputs the received result to the communication controller 106.

The communication controller 106 cancels restriction on communication with respect to the content on the basis of the operation reception result. The communication controller 106 may determine the type of content to be communicated and restrict communication according to the determined content type in a case that restricting communication. The communication controller 106 may determine content including images and automatically restrict communication with respect to this content.

The communication controller 106 may monitor a communication state of the transmission/reception unit 108 and restrict communication in a case that heavy congestion in communication occurs. The communication controller 106 may monitor a communication state of the transmission/reception unit 108 in a state in which communication is restricted due to heavy congestion in communication, and in a case that it is determined that a surplus is generated in communication volume to a degree to which restricted content can be canceled, may automatically cancel restriction on the content.

However, the communication controller 106 excludes communication with respect to reproduction and output of display and images stored in a terminal and the like mounted in the host vehicle M from restriction targets. For example, in a case that the vehicle communication device 100 has acquired sign information of a traffic sign among items stored in out-of-vehicle communication devices, the communication controller 106 does not restrict communication because a communication volume is low in a case that a sign label stored in advance in the host vehicle M is output to the display 112 through in-vehicle communication.

Even in a case that communication is restricted, the communication controller 106 may also exclude communication of information about driving assistance or automated driving of the host vehicle M from communication restriction targets or set a low priority in a case that the communication is selected as a communication restriction target in communication of information about driving assistance or automated driving of the host vehicle M.

The communication controller 106 excludes communication with respect to traveling of the host vehicle M in driving assistance or automated driving of the host vehicle M from restriction targets. For example, communication with respect to traveling of the host vehicle M may include communication with respect to vehicle control information such as starting of a vehicle driving source, acceleration/deceleration, stopping, keeping the vehicle stopped, and the like necessary for driving assistance or automated driving of the host vehicle M, abnormality information on the vehicle, abnormality information for neighboring vehicles, and the like.

Communication with respect to vehicle control information may be communication performed in a case that cooperative driving is performed according to vehicle-to-vehicle communication between the host vehicle M and a preceding vehicle, for example. In communication with respect to vehicle control information, for example, vehicle control information including a control command for causing the host vehicle M to start, accelerate/decelerate, stop, maintain a stop state and the like at a predetermined timing is transmitted from another vehicle in association with a traveling states of the other vehicle.

The host vehicle M travels according to the received control command. In addition, communication with respect to vehicle control information may include communication performed between an out-of-vehicle communication device and the host vehicle M in order to control a fully autonomous vehicle.

When driving assistance for the host vehicle M is performed according to a remote operation, the host vehicle M receives vehicle control information including a control command for causing the host vehicle M to start, decelerate, stop and maintain a stop state, which is transmitted from a remote location through a network, and travels according to the received control command.

Communication with respect to abnormal information on the vehicle may be communication in a case that an abnormality such as a trouble occurring in the host vehicle M has been detected, for example, and is communication for notifying a predetermined organization such as a road service, a fire station or a police station of the abnormality in response to details of the abnormality.

Communication with respect to abnormality information and the like on neighboring vehicles is communication with respect to information on accidents and troubles occurring in vehicles around the host vehicle M which affect traveling of the host vehicle M, which is acquired through vehicle-to-vehicle communication, road-to-vehicle communication, and communication with a base station and the like.

The communication controller 106 makes selection as a communication restriction target difficult by setting a low priority for a restriction target in restriction on communication and secures a communication speed of communication with respect to traveling of the host vehicle M. The host vehicle M may decrease the speed thereof below a speed at which the host vehicle M travels according to automated driving in a case that a communication speed of communication with respect to traveling of the host vehicle M needs to be restricted.

According to the above-described configuration, in the vehicle communication system 1, all contents are restricted and communication cannot be performed with respect to content necessary for use of the host vehicle M, and thus traveling of the host vehicle M is prevented from being hindered. Furthermore, according to the above-described configuration, the vehicle communication system 1 can improve convenience of vehicle traveling such as driving assistance and automated driving or prevent necessary communication from being restricted in use of functions as a public transportation means.

The communication controller 106 excludes communication for acquiring a surrounding situation of the host vehicle M from communication restriction targets or sets a low priority in a case that the communication is selected as a communication restriction target. Communication for acquiring a surrounding situation of a vehicle may be vehicle-to-vehicle communication, a road-to-vehicle communication, GPS communication, server communication, or communication with a terminal of a pedestrian or the like, for example.

For example, the communication controller 106 may acquire information about a surrounding situation of the host vehicle M on a route along which the host vehicle M will travel according to vehicle-to-vehicle communication and road-to-vehicle communication. Information about a surrounding situation of the host vehicle M may be information about a surrounding situation of the host vehicle which affects traveling of the host vehicle M in the future, such as traffic regulations information, construction information, traffic regulations, accident information, and congestion information.

In addition, communication for acquiring a surrounding situation of the host vehicle M includes communication for improving traveling accuracy in traveling of the host vehicle M, such as GPS communication, server communication, and communication with a terminal of a pedestrian or the like, and communication of information about protection of pedestrians.

GPS communication is communication for acquiring positional information and time information of the host vehicle M, for example. Server communication is communication for acquiring online navigation information, for example. The server communication may include communication for acquiring positional information of the host vehicle M obtained through communication with a base station. Communication with a terminal of a pedestrian or the like is communication for acquiring positional information of the pedestrian through communication with the terminal of the pedestrian present around the host vehicle M, for example. According to the aforementioned configuration, communication with respect to driving for enhancing vehicle stability and acquisition of a surrounding situation necessary for traveling is prevented from being restricted.

The communication controller 106 excludes communication of information about emergency notification of the host vehicle M from communication restriction targets or sets a low priority in a case that the communication is selected as a communication restriction target. The communication controller 106 excludes communication of information related to protection or biometric information of an occupant of the host vehicle M from communication restriction targets or sets a low priority in a case that the communication is selected as a communication restriction target. Communication with respect to protection of an occupant includes communication for issuing emergency notification to a fire station with respect to a physical abnormality occurring in an occupant in the host vehicle M, communication for receiving guidance such as emergency treatment from a doctor of a medial institution such as a hospital, or the like.

When an abnormality occurs such as unconsciousness of an occupant, if another occupant issues emergency notification by operating the display 112, the communication controller 106 issues emergency notification to a communication device of a predetermined organization such as a fire station outside the vehicle through the transmission/reception unit 108. Communication with respect to biometric information of an occupant is communication for monitoring changes in the state of the occupant such as drowsiness and unconsciousness of the occupant and communication for issuing emergency notification.

When the recognition unit 117 has recognized changes in the physical condition of the occupant, drowsiness, and changes in the state of the occupant such as unconsciousness, the communication controller 106 transmits information about the recognized state of the occupant of the host vehicle M to a predetermined organization such as a medical institute. The information about the state of the occupant may be monitor information to be monitored in a medical institute such as the blood pressure, heart rate, and body temperature of an occupant having a chronic disease, for example. The communication controller 106 transmits the information about the state of the occupant to the medical institute at a predetermined timing. When an abnormality in the state of the occupant has been discovered from monitoring results of the medical institute, the communication controller 106 performs communication for receiving guidance such as emergency treatment from a doctor and the like of the medical institute such as a hospital.

The communication controller 106 excludes communication of information related to protection or biometric information of an occupant of the host vehicle M from communication restriction targets or sets a low priority in a case that the communication is selected as a communication restriction target. Accordingly, it is possible to prevent communication with respect to health and safety of the occupant from being restricted.

The communication controller 106 excludes communication of information related to an abnormality that has occurred in the host vehicle M from communication restriction targets or sets a low priority in a case that the communication is selected as a communication restriction target. When the communication controller 106 has detected an abnormality that has occurred in the host vehicle M, the communication controller 106 notifies a communication device of a predetermined organization such as a fire station, a police station or a road service of the abnormality through the transmission/reception unit 108. The abnormality that has occurred in the host vehicle M may be an abnormality such as an accident like a collision and the like occurring in the host vehicle M or around the host vehicle M, for example.

When the recognition unit 117 has recognized the abnormality of the occupant or the host vehicle M on the basis of detection results of the detection unit 116, the communication controller 106 notifies a communication device of a predetermined organization such as a fire station, a police station or a road service of the abnormality through the transmission/reception unit 108.

Accordingly, it is possible to prevent communication of emergency from being restricted in the vehicle communication system 1. The communication controller 106 preferentially restricts communication with respect to content including images unassociated with communication content related to traveling of the host vehicle M or protection or biometric information of an occupant.

The navigation device 118 may set a route by preferentially selecting a route passing through a connection area in which connection to an out-of-vehicle communication device such as a base station of a wireless LAN can be performed in a case that a travel route is set, for example.

The communication controller 106 preferentially connects communication with the base station of the wireless LAN in a case that the vehicle passes through an area in which a wireless LAN service is provided. In route setting, an area in which the wireless LAN service is provided is a place having dense people and buildings, such as a city area, in many cases. Accordingly, in a case that such route setting is performed, congestion or delay of an arrival time at a destination is likely to occur due to a time factor or a place factor. Hence, the display controller 104 causes the display 112 to display an operation screen IM3 for selecting whether to prioritize congestion avoidance or communication.

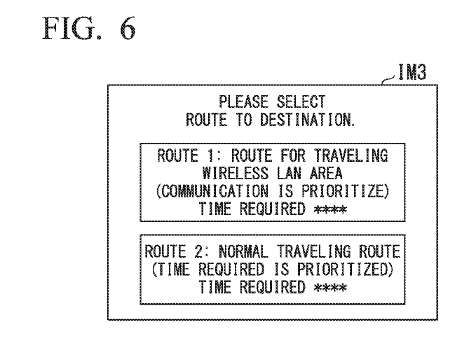

FIG. 6 is a diagram showing an example of details of the operation screen IM3. For example, the operation screen IM3 may display a route 1 that prioritizes communication and a route 2 that prioritizes a time required, and an occupant can select one of the routes by touching the display 112.

When such route selection is performed, the occupant can perform wireless communication that is not converted into an information usage amount using the vehicle communication device 100 or the in-vehicle user terminal P1 brought into the host vehicle M by the occupant and mounted in the host vehicle M. In addition, the occupant can be provided with a data communication service without caring about an information usage amount in a case that communication with the base station of the wireless LAN is performed using the in-vehicle user terminal P1 through the vehicle communication device 100 or directly.

When the occupant of the host vehicle M has set the amount of traffic of the vehicle communication device 100 to a predetermined amount, the occupant performs settlement for the amount of traffic of the vehicle communication device 100 by operating the vehicle communication device 100. Settlement for the amount of traffic may include changing an upper limit of the amount of traffic in addition to paying for the amount of traffic by the occupant, for example. In addition, settlement also includes increasing the upper limit of the amount of traffic as a reward obtained from display of advertisement on the exterior or interior of the host vehicle M and increasing the upper limit of the amount of traffic as a reward obtained as collateral of information provision performed by the occupant.

Here, the occupant may perform settlement for the amount of traffic using a communication device other than the vehicle communication device 100. Here, the other communication device can communicate with the vehicle communication device 100 and an external communication device of the host vehicle M. By performing such a process, the vehicle communication device 100 can provide services such as advertisement using data communication in the host vehicle M.

When the host vehicle M is used for car sharing or ridesharing, for example, the vehicle communication device 100 is used for connection of a plurality of communication devices (user terminals P1) used by a plurality of different occupants and an external communication device of the host vehicle M. However, in a case that a user views image content of the user terminal P1 through the display or the like in the host vehicle M, for example, if communication between the vehicle communication device 100 and the external communication device of the host vehicle M is performed on the basis of an operation of the in-vehicle user terminal P1, an amount of traffic is generated in the vehicle communication device 100 apparently.

Then, the amount of traffic allocated to the vehicle communication device 100 of the host vehicle M used for car sharing or ridesharing instantaneously exceeds the upper limit and thus communication of the vehicle communication device 100 is likely to be frequently restricted. Accordingly, in a case that the user terminal P1 is connected to the vehicle communication device 100 to perform communication with an external communication device of the host vehicle M, the communication controller 106 locks communication on the side of the vehicle communication device 100, handles details of communication as details of communication between the in-vehicle user terminal P1 and the external communication device and adds the amount of traffic generated due to this communication to the in-vehicle user terminal P1 on the basis of setting of the owner of the host vehicle M.

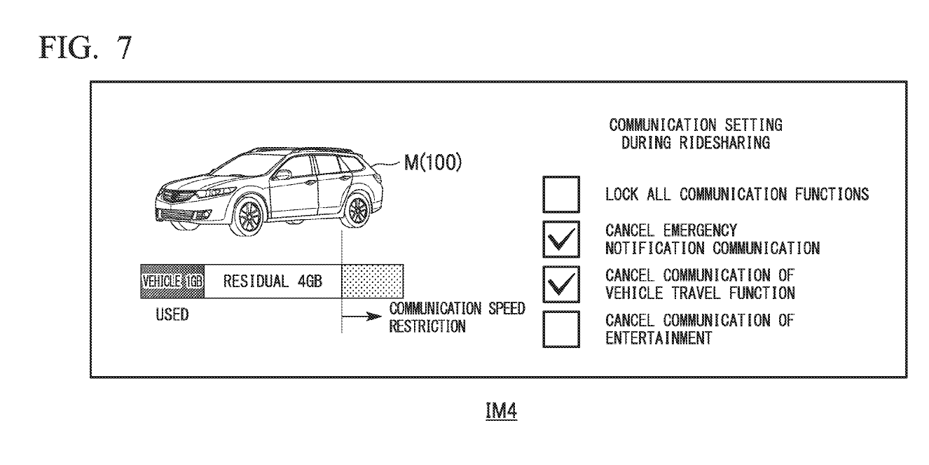

FIG. 7 is a diagram showing an example of details of a setting screen IM4 for restricting communication on the side of the vehicle communication device 100 during ridesharing. When communication is locked in the vehicle communication device 100, setting may be performed such that communication is not restricted with respect to content arbitrarily selected through the setting screen IM4 by the owner of the host vehicle M. In the example of FIG. 7, the owner of the host vehicle M selects restriction targets for which communication is restricted during ridesharing in the setting screen IM4.

However, in a case that setting for selecting communication of important content such as communication during driving assistance or emergency of the host vehicle M is performed through the setting screen IM4, communication on the side of the vehicle communication device 100 may be permitted with respect to such communication. When setting for selecting communication with respect to entertainment is performed through the setting screen IM4 as part of service provision, communication on the side of the vehicle communication device 100 may be permitted with respect to such communication.

The communication controller 106 transmits authentication information and setting information of the user terminal P1 performed in a case that the user terminal P1 is connected to the vehicle communication device 100 to the management server of the common carrier. The common carrier manages communication of the vehicle communication device 100 as communication of the user terminal P1 on the basis of the acquired authentication information and setting information.

The display controller 104 may display an authentication screen of the user terminal P1 on the display 112 or the display unit of the user terminal P1 in a case that the user terminal P1 is connected to the vehicle communication device 100. According to this communication method, an effective data communication service that guarantees fairness is provided and communication during emergency of an occupant and communication based on services are secured in a case that car sharing or ridesharing is performed using the host vehicle M.

### [Process Flow]

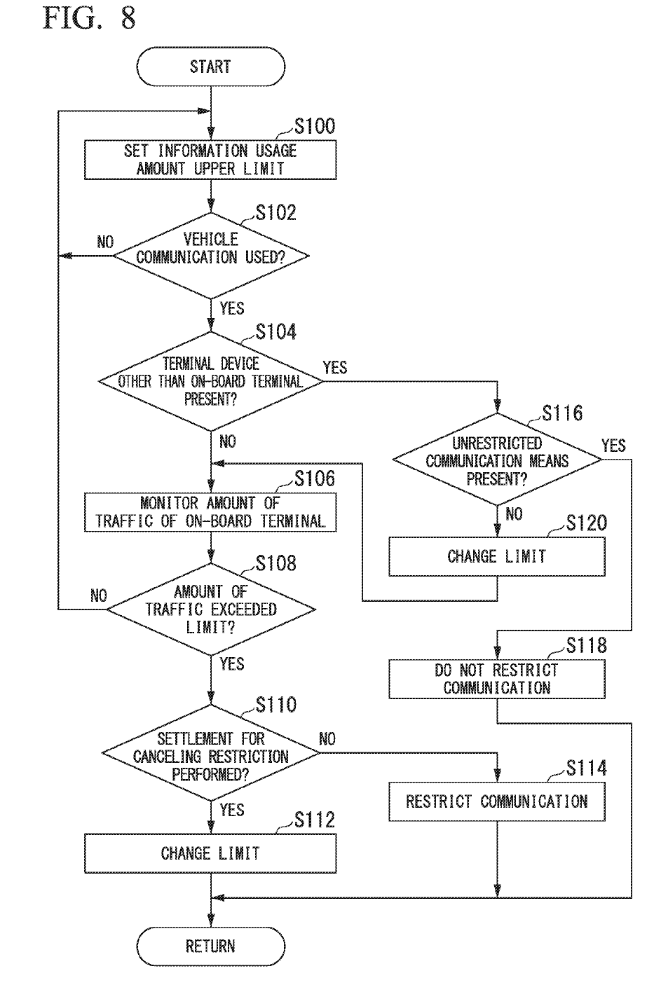

Next, a process executed in the vehicle communication system 1 will be described. FIG. 8 is a flowchart showing an example of a flow of a process executed in the vehicle communication system 1. The communication controller 106 sets an information usage amount upper limit in communication of the vehicle communication device (step S100). The communication controller 106 monitors whether communication of the vehicle communication device is started (step S102).

When a negative determination is obtained in step S102, the communication controller 106 returns the process to step S100. When a positive determination is obtained in step S102, the communication controller 106 determines whether a communication device other than the vehicle communication device has been connected (step S104). When a negative determination is obtained in step S104, the determination unit 102 monitors the amount of traffic of the vehicle communication device (step S106).

The determination unit 102 determines whether the amount of traffic of the vehicle communication device has exceeded a predetermined amount set in advance (step S108). When a negative determination is obtained in step S108, the communication controller 106 returns the process to step S100. When a positive determination is obtained in step S108, the communication controller 106 determines whether settlement that cancels restriction on communication has been performed (step S110).

When a positive determination is obtained in step S110, the communication controller 106 changes the limit of the amount of traffic of the vehicle communication device (step S112). When a negative determination is obtained in step S110, the communication controller 106 restricts the amount of traffic of the vehicle communication device (step S114). When it is determined that there is a communication device other than the vehicle communication device in step S104, the communication controller 106 determines whether there are other communication means that perform unrestricted communication such as a wireless LAN (step S116). When a negative determination is obtained in step S116, the communication controller 106 does not restrict communication (step S118).

When a negative determination is obtained in step S116, the communication controller 106 changes the limit of the amount of traffic of the vehicle communication device by summing the communication volume of the vehicle communication device and the communication volume of the communication device other than the vehicle communication device, or the like (step S120). Thereafter, the communication controller 106 returns the process to step S106. The process of the flowchart ends by executing the above-described process.

According to the above-described embodiment, the vehicle communication system 1 can effectively use communication resources of a vehicle including a communication function. The vehicle communication system 1 can secure communication of content other than restricted content by restricting communication for each content of a terminal that performs communication. The vehicle communication system 1 can also secure available communication volume by summing, handing over, or the like the amount of traffic of the vehicle communication device and the amount of traffic of the user terminal P1 in a case that communication of any of the vehicle communication device and the user terminal P1 possessed by an occupant is restricted.

The vehicle communication system 1 can reduce loads in a process on the side of a wireless base station by restricting communication in the vehicle communication device. The vehicle communication system 1 can equally provide communication environments to many users in a case that vehicles capable of performing communication area spread by performing such restriction.

### [Hardware Configuration]

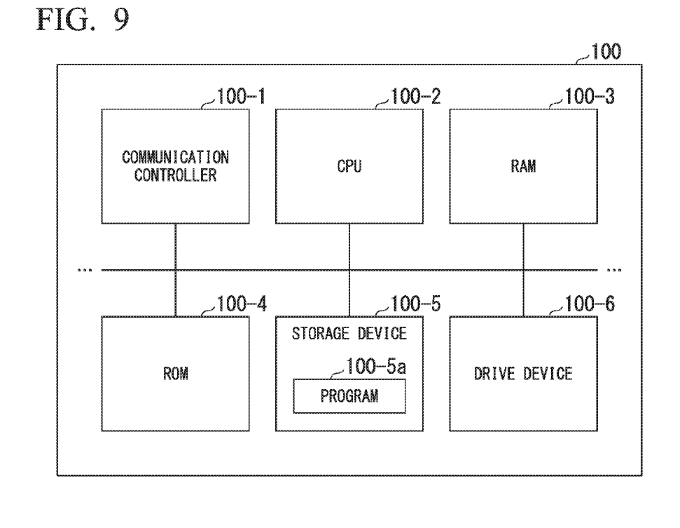

FIG. 9 is a diagram showing an example of a hardware configuration of the vehicle communication device 100. As shown, the vehicle communication device 100 included in the vehicle communication device of the embodiment has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or an hard disk drive (HDD), a drive device 100-6, and the like are connected through an internal bus or a dedicated communication line. The communication controller 100-1 performs communication with components other than the vehicle communication device 100. A program 100-5a executed by the CPU 100-2 is stored in the storage device 100-5. This program is developed in the RAM 100-3 according to a direct memory access (DMA) controller (not shown) or the like and executed by the CPU 100-2. Accordingly, some or all of the determination unit, the display controller, the communication controller, and the transmission/reception unit are realized.

The above-described embodiment can be represented as follows.

A vehicle communication device for controlling communication between a vehicle communication device mounted in a vehicle and an out-of-vehicle communication device, including:

a storage device which stores a program; and

a hardware processor,

in which the hardware processor is configured to determine whether an information usage amount that is an index value indicating the amount of information communicated between the vehicle and the out-of-vehicle communication device has exceeded a predetermined amount and to restrict communication between the vehicle and the out-of-vehicle communication device in a case that the information usage amount has exceeded the predetermined amount by executing the program stored in the storage device.

While forms for embodying the present invention have been described using an embodiment, the present invention is not limited to the embodiment and various modifications and substitutions can be made without departing from the spirit or scope of the present invention. For example, although communication restriction is performed in the communication controller 106 on the side of the host vehicle M in the above-described embodiment, communication restriction may be performed on the side of the communication target W outside the host vehicle M. An on-board communication device may be tethered through a user terminal.

What is claimed is:

1. A vehicle communication control method for controlling communication between a vehicle communication device mounted in a vehicle and an out-of-vehicle communication device, the method comprising:
causing one or more computers
to determine whether an information usage amount that is an index value indicating the amount of information communicated between the vehicle communication device and the out-of-vehicle communication device has exceeded a predetermined amount, and
to restrict communication between the vehicle and the out-of-vehicle communication device in a case that the information usage amount has exceeded the predetermined amount.

2. The vehicle communication control method of claim 1, wherein there is a case in which the vehicle communication device receives content reproduced by an on-board device from the out-of-vehicle communication device, and the one or more computers determine the type of the content reproduced in the on-board device that performs communication and restrict the communication according to the determined content type.

3. The vehicle communication control method of claim 1, wherein the vehicle communication device performs communication with respect to traveling of the vehicle, and the one or more computers exclude communication of the vehicle communication device with respect to traveling from restriction targets for the communication or set a low priority in a case that the communication is selected as a restriction target of the communication.

4. The vehicle communication control method of claim 1, wherein the vehicle communication device performs communication for acquiring a surrounding situation of the vehicle, and the one or more computers exclude the communication for acquiring the surrounding situation of the vehicle from restriction targets for the communication or set a low priority in a case that the communication is selected as a restriction target for the communication.

5. The vehicle communication control method of claim 1, wherein the vehicle communication device performs communication with respect to driving assistance or automated driving of the vehicle, and the one or more computers exclude the communication of information about driving assistance or automated driving of the vehicle from restriction targets for the communication or set a low priority in a case that the communication is selected as a restriction target for the communication.

6. The vehicle communication control method of claim 1, wherein the one or more computers exclude communication of information about a state of an occupant of the vehicle from restriction targets for the communication or set a low priority in a case that the communication is selected as a restriction target for the communication.

7. The vehicle communication control method of claim 1, wherein the one or more computers exclude communication of information about an emergency notification of the vehicle from restriction targets for the communication or set a low priority in a case that the communication is selected as a restriction target for the communication.

8. The vehicle communication control method of claim 1, wherein the one or more computers exclude traveling of the vehicle, or communication of information related to protection or biometric information of an occupant of the vehicle from restriction targets for the communication or set a low priority in a case that the communication is selected as a restriction target for the communication.

9. The vehicle communication control method of claim 1, wherein the one or more computers preferentially restrict the communication with respect to content including images reproduced in the on-board device.

10. The vehicle communication control method of claim 1, wherein the one or more computers receive an operation of selecting content for which the communication is restricted by an occupant of the vehicle, select the content for which the communication is restricted according to the received operation and preferentially restrict the communication with respect to the selected content.

11. The vehicle communication control method of claim 1, wherein the predetermined amount is set for the vehicle communication device installed in the vehicle.

12. The vehicle communication control method of claim 1, wherein the vehicle communication device mounted in the vehicle and the out-of-vehicle communication device are connected in a wired or wireless manner, and the one or more computers set the predetermined amount by summing the communication volume of the vehicle communication device and the communication volume of a communication device other than the vehicle communication device, which is brought into the vehicle, or the communication volume of the out-of-vehicle communication device.

13. A vehicle communication control method between a vehicle communication device mounted in a vehicle and an out-of-vehicle communication device, the method comprising:
causing one or more computers
to connect the vehicle communication device to the out-of-vehicle communication device or a communication device brought into the vehicle through communication, and
to switch communication volumes between the vehicle communication device and the out-of-vehicle communication device or the communication device brought into the vehicle.

14. A vehicle communication control method comprising:
causing one or more computers to perform communication such that a communication volume or a data usage amount set in a communication device brought into a vehicle is not consumed in a case that the communication device is caused to communicate with an out-of-vehicle communication device through a vehicle communication device in a state in which the vehicle communication device mounted in the vehicle and the out-of-vehicle communication device are wirelessly connected.

15. The vehicle communication control method of claim 14, wherein, in a case that the one or more computers set a traveling route of the vehicle, the one or more computers perform route setting for preferentially selecting a route passing through a connection area in which the one or more computers are connectable to the out-of-vehicle communication device.

16. A vehicle communication control method comprising:
in a case that a predetermined amount that restricts an amount of traffic of a vehicle communication device which is installed in a vehicle and can communicate with an out-of-vehicle communication device is set by an occupant of the vehicle, one or more computers performing settlement for the amount of traffic through any one of the vehicle communication device and a communication device other than the vehicle communication device,
wherein the other communication device can communicate with the vehicle communication device and the out-of-vehicle communication device.

17. The vehicle communication control method of claim 16, wherein, in a case that the vehicle communication device is used for communication between other communication devices used by a plurality of occupants and the out-of-vehicle communication device, the one or more computers handle details of communication of the vehicle communication device as details of communication between the other communication devices and the out-of-vehicle communication device and add the amount of traffic of the details of communication to the other communication devices.

18. A vehicle communication device for controlling communication between a vehicle and another communication device, comprising:
a determination unit which is configured to determine whether an information usage amount that is an index value indicating the amount of information communicated between the vehicle and the other communication device has exceeded a predetermined amount; and
a controller which restricts communication between the vehicle and the other communication device in a case that the determination unit determines that the information usage amount has exceeded the predetermined amount.
